(19) United States
(12) Patent Application Publication
(10) Pub. No.: US 2004/0040895 A1
(43) Pub. Date: Mar. 4, 2004

(54) Plansifter for separating the products of cereal milling

(75) Inventor: Maurizio Fiorini, Pieve D'Olmi (IT)

Correspondence Address: R. Neil Sudol, 714 Colorado Avenue, Bridgeport, CT, 06605-1601, US

(73) Assignee: OCRIM S.p.A., CREMONA (IT)

(21) Appl. No.: 10/628,216

(22) Filed: Jul. 28, 2003

(30) Foreign Application Priority Data
Sep. 4, 2002 (IT) MI2002 A 001884

(51) Int. Cl. B07B 1/04; B07B 1/28

(52) U.S. Cl. 209/359; 209/360

(57) ABSTRACT

A plansifter for separating the products of cereal milling, which includes a plurality of compartments arranged vertically, a plurality of sieves stacked in each compartment, a rotating mass assembly to keep under vibration the plurality of compartments and therefore the plurality of sieves, and flexible suspension assemblies to allow vibration. The plurality of compartments has a binary configuration, forming pairs of compartments that are symmetrical and aligned with respect to the rotating mass assembly that is arranged centrally. The plansifter allows a reduced footprint for an equal performance, allows to provide a modular construction that can be extended according to future requirements, to simplify mechanical construction and maintenance, and to distribute the flexible suspension assemblies according to requirements.

### BACKGROUND OF THE INVENTION

1. Field of the Invention

The present invention relates to a plansifter for separating the products of cereal milling. Cereals are generally milled by roller mills. After milling it is necessary to separate the products of the process by sorting according to particle size. Plansifters perform this task with a plurality of compartments arranged vertically so as to contain a plurality of sieves stacked in each compartment. A rotating mass assembly keeps under vibration the plurality of compartments and therefore the plurality of sieves, generally transmitting the vibration to a supporting frame. Flexible suspension assemblies suspend the structure so that it can oscillate in order to allow the free vibration generated by the rotating masses.

The above is the field of industrial application of the invention.

2. Description of the Prior Art

Devices of this type are known; for example, in the traditional layout, more commonly used in the field, the machine is constituted by a plurality of compartments, which are arranged along two rows and inside which the sieves intended for screening are stacked.

The two rows of compartments are rigidly connected to a central structure, known as “frame”, at the center of which the eccentric mass, known as “counterweight”, is mounted, imparting to the entire machine the planar rotary motion required to achieve the screening action and the consequent separation of the product into different particle sizes. The compartments are closed on three sides, and the fourth side is closed by a door for access to the sieves.

The plansifter, understood as the set of compartments and the frame, is suspended by means of four sets of flexible members known as “rods”.

However, it has been found that these known devices have a high ratio between the surface useful for sifting and the footprint of the machine. This is a severe drawback, since these machines are inherently very bulky, and it has an important effect on the overall cost of the building that must contain the mill. It is in fact necessary to accommodate, in certain cases, several of these devices.

In order to try to limit this problem, patent DE 19746678C1 (Berga), dated May 1999, teaches a reduction in the ratio between useful surface and footprint by inserting two compartments at the ends of the central frame.

With respect to the conventional arrangement, one obtains a saving in the footprint of the machine which depends on the number of compartments: the saving is 25% for an eight-compartment plansifter and 17% for a 12-compartment plansifter, while there is no footprint reduction for four-compartment machines.

The plansifter described in the cited patent, however, entails a considerable mechanical disadvantage: the actuation assembly, contained in the central frame, cannot be accessed unless one of the compartments arranged at its ends is completely disassembled.

Accordingly, inspection and maintenance operations are extremely awkward.

Patent 0112643 (Simon) dated July 1984 teaches to reduce the ratio between the surface useful for screening and the footprint by eliminating the so-called frame: the two rows of compartments containing the sieves directly flank each other.

With respect to the conventional arrangement, one obtains a saving in machine footprint that depends on the number of compartments: one has a 17% saving for an 815 compartment plansifter and a 23% saving for a 12-compartment plansifter, while there is no reduction in footprint for 4-compartment machines.

In this solution, two mutually opposite compartments arranged at the end of each row contain two eccentric masses instead of sieves; the masses must be synchronized by means of appropriate transmission systems, so as to impart the necessary planar rotary motion to the machine.

However, these transmissions necessarily have to run along the entire length of the machine, entailing thereby not only a considerable mechanical complication and an additional cost, but also an increased risk of injury due to moving mechanical parts, which accordingly require adequate protections, which of course must run along the entire length of the device. Furthermore, in case of a fault affecting this complicated transmission, there is the serious risk that the eccentric masses lose their synchronization and apply unexpected and destructive forces to the structure of the device, with the possibility of severe damage. In practice, therefore, the reliability of the assembly is reduced dangerously. At the very least, the two motion generation assemblies constituted by the two eccentric masses must be absolutely synchronized: any phase shifts of the masses would in fact apply unbalanced stresses to the components of the machine, with consequent negative effects on structural strength and uniformity of motion.

Finally, the assembly constituted by the motion components, the counterweights, the actuation shafts, the supports, the bearings, the pulleys, the belts and the motor constitutes a significant part of the total cost of the machine: the constructive solution considered entails a “duplication” of these components, with a consequent significant cost increase with respect to the conventional solution.

U.S. Pat. No. 2,723,751 has an inner channel for the flow of the product. This channel requires space and reduces the space available for the sieves. So it goes in a direction opposite to that of the present invention. Also, it has four compartments and it is technically impossible to increase the number of the compartments.

U.S. Pat. No. 3,815,741 discloses an open arrangement plansifter, in which the compartments are not closed, as in the field of the present invention. Furthermore, even increasing the number of compartments, it is only possible to obtain the above-described conventional arrangement.

### SUMMARY OF THE INVENTION

The aim of the present invention is to allow to reduce significantly the ratio between the surface useful for sifting and the footprint of the machine, without encumbering the mechanical structure and maintenance with other problems but if anything reducing the existing ones.

Another object is to allow to provide a modular construction that can be extended in the future, according to requirements, without mechanical difficulties.

Another object of the present invention is to overcome these drawbacks with a plansifter for separating products resulting from milling cereals, comprising a plurality of vertically arranged compartments, a plurality of sieves stacked inside each said compartment, a member having rotating masses in order to keep said plurality of compartments and thus said plurality of sieves vibrating, and flexible suspension members to allow vibration, characterized in that said plurality of compartments have a binary layout forming compartments symmetrical and aligned with respect to said centrally-placed rotating mass member; said binary layout being chosen between four symmetrical pairs of compartments and six symmetrical pairs of compartmens.

### BRIEF DESCRIPTION OF THE DRAWINGS

The present invention will become better apparent with reference to the description of two embodiments of the invention, with reference to the drawings, given by way of non-limitative example of the invention, wherein:

FIG. 1 is a side view of the plansifter according to a first embodiment of the invention;

FIG. 2 is a plan view of the sifter according to FIG. 1; and

FIG. 3 is a perspective view of a second embodiment of the invention.

### DESCRIPTION OF THE PREFERRED EMBODIMENTS OF THE INVENTION

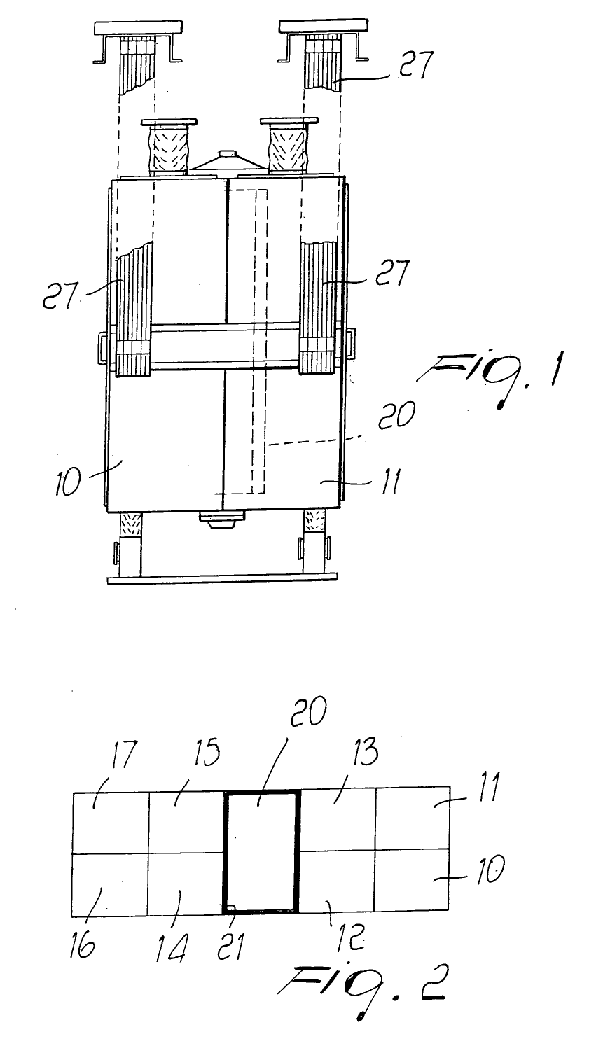

With reference to FIGS. 1 to 3, a plurality of compartments 8 to 19 are arranged vertically so as to contain a plurality of sieves stacked in each compartment, which are not shown in the figures since they belong to the known art. A rotating mass assembly 20 keeps under vibration a central frame 21, the plurality of connected compartments, and therefore the plurality of sieves contained in the compartments 8 to 19.

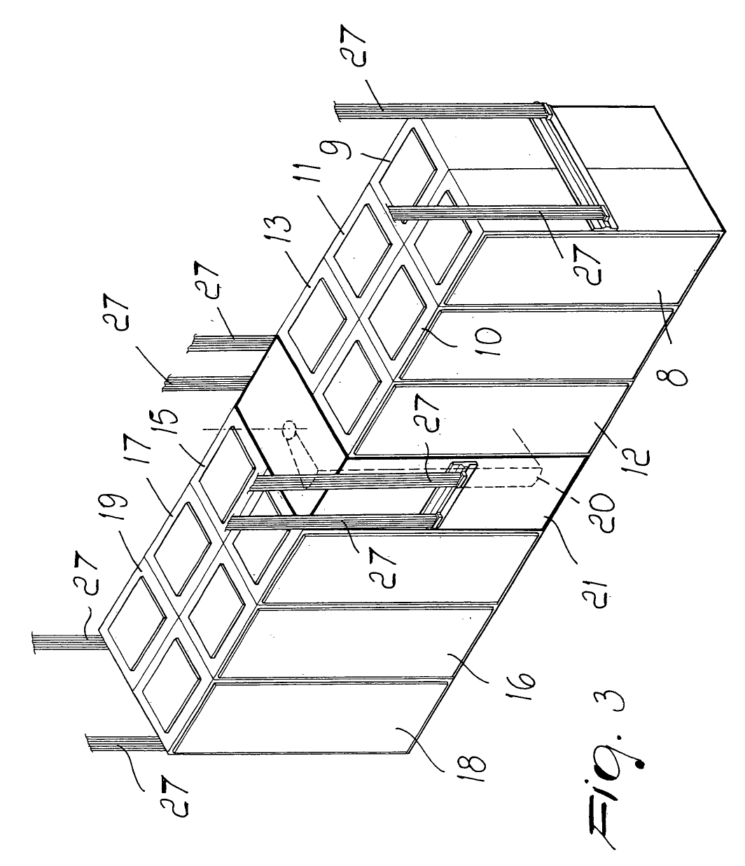

The plurality of compartments 8 to 19 have a binary configuration, forming pairs of compartments 8-9, 10-11, 12-13, 14-15, 16-17, 18-19, which are symmetrical and aligned with respect to the rotating mass assembly, which is arranged centrally. The binary configuration is symmetrical, since it is formed by symmetrical pairs; for example, it is formed by two symmetrical pairs of compartments 12-13 and 14-15, four symmetrical pairs of compartments 10-11, 12-13, 14-15, 16-17, or six symmetrical pairs of compartments 8-9, 10-11, 12-13, and 14-15, 16-17, 18-19. The configuration with four symmetrical pairs of compartments is described with particular reference to the embodiment of FIG. 2. The configuration with six symmetrical pairs of compartments is described with particular reference to the embodiment of FIG. 3.

Each pair 8-9, 10-11, 12-13 and 14-15, 16-17, 18-19 forms, in plan view, a rectangle with a long side and a short side; the long sides of all the rectangles of all the pairs are parallel.

The rotating mass assembly 20 is arranged in a central frame 21 that forms, in plan view, a rectangle, the longer side of which is parallel to the long sides of the rectangles of the pairs 8-9, 10-11, 12-13 and 14-15, 16-17, 18-19. The rotating mass assembly 20 has a rotation axis 25 that lies substantially on the plane that connects the two compartments that form each pair. The term “rotation axis” is used to reference the actual rotation axis if a single rotating mass assembly is used or the resulting virtual axis if a plurality of separate assemblies are used. If more than one assembly is used, all the assemblies must of course be accommodated centrally in the frame 21.

The plansifter according to the invention has a modular configuration which includes: a central frame 21, which contains the rotating mass assembly; a mechanical connection means for connecting two pairs of central compartments 12-15 to the central frame 21 and optionally, according to requirements, two pairs 10-11 and 16-17 or four pairs 8-11 and 16-19 of lateral compartments to be connected to the two pairs of central compartments 12-15. The mechanical connection means can be formed conveniently by simple bolts.

Flexible suspension assemblies 27 suspend in an oscillating manner the structure 8-9, 10-11, 12-13 and 14-15, 16-17, 18-19, 21 in order to allow the free vibration generated by the rotating masses 20. The suspension assemblies 27 are connected to the compartments, so that the number of suspension assemblies is variable according to the number of pairs of compartments installed. In this manner it is possible to distribute in an optimum manner, according to requirements, the structural stresses to which the machine is subjected during motion.

It has been found that the invention allows to achieve the intended aim and all the objects; in particular, with respect to the conventional layout, it is possible to obtain a reduction in footprint of 17% for the arrangement with four pairs of compartments and of 23% for the arrangement with six pairs of compartments. Furthermore, the central frame 21 can be accessed perfectly from the outside in order to allow easy maintenance that does not cause an extended machine downtime. Access is actually simplified with respect to the conventional arrangement, since the frame 21 is shorter than the conventional central frame. Moreover, special transmission components are not necessary, since the rotating mass assembly can be provided easily by means of a single rotating shaft.

The plansifter according to the invention is susceptible of numerous modifications and variations, within the scope of the appended claims. In particular, for example, the arrangement of the rotating masses 20 or the suspensions 27 can be changed as required by specific applications.

1. A plansifter for separating products resulting from milling cereals, comprising a plurality of vertically arranged compartments, a plurality of sieves stacked inside each said compartment, a member having rotating masses in order to keep said plurality of compartments and thus said plurality of sieves vibrating, and flexible suspension members to allow vibration, wherein said plurality of compartments have a binary layout forming compartments symmetrical and aligned with respect to said centrally-placed rotating mass member; said binary layout being chosen between four symmetrical pairs of compartments and six symmetrical pairs of compartmens.

2. The plansifter according to claim 1, wherein each pair forms, in plan view, a rectangle with a long side and a short side, the long sides of all the rectangles of all of said pairs being parallel.

3. The plansifter according to claim 2, wherein said rotating mass assembly is arranged in a central frame that forms, in plan view, a rectangle, the long side of which is parallel to said long sides of said rectangles of said pairs.

4. The plansifter according to claim 1, having a modular configuration and comprising: a central frame, which contains said rotating mass assembly, a mechanical connection means for connecting two pairs of central compartments to said central frame and optionally, as required, two or four pairs of lateral compartments to be connected to said two pairs of central compartments.

5. The plansifter according to claim 4, wherein said suspension assemblies are connected to said compartments, so that the number of suspension assemblies is variable according to the number of installed compartments.

6. The plansifter according to claim 4, wherein the rotating mass assembly has a rotation axis that lies substantially on the plane that connects the two compartments that form each pair.
